(19) United States
(12) Patent Application Publication
(10) Pub. No.: US 2017/0086610 A1
(43) Pub. Date: Mar. 30, 2017

(54) DETERRENT AND ALERT SYSTEM FOR A BEVERAGE CONTAINER

(71) Applicant: NEW POTATO TECHNOLGIES, INC., WILMINGTON, NC (US)

(72) Inventors: STUART E. ROSS, WILMINGTON, NC (US); HARRY C. BONSER, WILMINGTON, NC (US)

(73) Assignee: NEW POTATO TECHNOLOIGIES, INC., WILMINGTON, NC (US)

(21) Appl. No.: 15/277,536

(22) Filed: Sep. 27, 2016

Related U.S. Application Data
(60) Provisional application No. 62/233,364, filed on Sep. 27, 2015.
(60) Provisional application No. 62/233,395, filed on Sep. 27, 2015.

(51) Int. Cl. A47G 19/22; B65D 51/24; G08B 13/08

(52) U.S. Cl. CPC A47G 19/2227; G08B 13/08; B65D 51/248; A47G 2019/2244

(57) ABSTRACT

A system for deterring the placement of a foreign substance in a user's beverage and for alerting the user to such attempts including a sensor that detects movement or agitation, such as an accelerometer, contained in a substantially flat housing, preferably configured to provide a surface on which a coaster and/or a beverage can rest. Said system includes means for the sensor to transmit data to a processor that is enabled with software capable of communicating with an external device or activating an alarm system associated with the housing.

### CROSS-REFERENCE TO RELATED APPLICATIONS

This application claims the benefit of priority to U.S. Provisional Application No. 62/233,395 filed on Sep. 27, 2015. The content of U.S. Provisional Application No. 62/233,395 filed on Sep. 27, 2015 is incorporated by reference in its entirety. This application also claims the benefit of priority to U.S. Provisional Application No. 62/233,364 filed on Sep. 27, 2015. The content of U.S. Provisional Application No. 62/233,364 filed on Sep. 27, 2015 is incorporated by reference in its entirety.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### BACKGROUND OF THE INVENTION

(a) Field of the Invention

The present invention is in the technical field of warning systems, specifically, warning systems that alert a user of an attempt to contaminate a beverage. More particularly, the present invention is in the technical field of systems designed to alert a potential victim when someone tampers with their beverage by introducing a foreign substance into the beverage.

(b) Background Art

The advent of various amnesia inducing drugs, commonly referred to as date rape drugs, has created a serious societal problem. More specifically, people use drugs such as Rohypnol and gamma hydroxybutyric (GHB) to poison the beverages of unsuspecting victims, often in public social settings. Typically, the offender will place such a drug in the drink of their victim when the victim is not paying attention to the drink or otherwise in control of their beverage container. This is such a common problem that young women are oftentimes counseled not to accept a drink in an open container from anyone other than a bartender.

This problem is not new so it is no surprise that other inventors have attempted to develop devices and systems to prevent someone from introducing a substance into another person's beverage. For example, Virginia M. Drogo filed an application on a beverage lid designed to prevent the introduction of substances into a user's drink that can be found in USPTO Publication Number US2013/0082067 (hereinafter the “Drogo Reference”). The Drogo reference discloses a drink lid made of plastic and/or elastic material that is meant to be a one-size-fits-all lid for beverages. The lid prevents the introduction of a substance into the beverage container simply by covering the opening of the mouth of the container. The Drogo reference also teaches the use of messages being printed on the portion of the lid that allow the user to put would-be predators on notice that they are aware of the problem of date rape. The obvious drawback to this system is that it still requires the user to pay attention to whether or not someone removes or displaces the lid far enough to introduce a substance into the beverage. If the user or another person does not witness someone attempt to contaminate the beverage then the purpose of the device is defeated. In other words, a lid helps to prevent someone from introducing a substance into a beverage container, but it does not alert the user that such an act has transpired.

Another group of inventors developed and disclosed a method of detecting a date rape drug once the drug has already been introduced into the beverage (disclosed in PCT Application Number PCT/US2002/015088, hereinafter the “Glover et al. Reference”). The Glover et al. method requires the user to “test” the beverage by taking a sample of the beverage, placing it on the indicator and observing the indicator to see if the test results are positive. This method requires the user to wait until the sample has dried to detect the results of the test. In addition, if the user has left their beverage unattended or otherwise stopped paying attention to it, they would need to retest the beverage before consuming any more of it which makes the system rather cumbersome to use effectively. While this may be a practical way to test one's beverage if the user suspects the beverage has been contaminated, it does nothing to prevent the introduction of a substance into a beverage when the user is not paying attention to the beverage. In addition, it is likely there are drugs that this system cannot detect which could lead to a user to be misinformed as to whether their beverage was contaminated or not.

Yet another solution to the problem of date rape drugs being introduced into a user's beverage was presented by Go Simon Sunatoriin in Canadian Application Number CA2422687 (hereinafter the “Sunatoriin Reference”). The Sunatoriin Reference discloses a cylindrical collapsible tube-like structure that can enclose a beverage container with a lid that can be locked into place. While this system would probably make it quite difficult for someone to access the beverage, it will also make it difficult for the user to access the beverage. Moreover, should the user leave their beverage unattended, the system is only effective to the extent someone cannot find a way to unlock and remove the lid. Furthermore, the Sunatoriin reference does not teach a method of alerting a user when their beverage has been contaminated.

As a result, there is still a need for a system or device and a method that would both deter and/or prevent someone from introducing a substance into a user's beverage and that can alert the user to an attempt to do so.

### BRIEF SUMMARY OF THE INVENTION

The present application discloses a system and method for deterring someone from attempting to introduce a substance into a user's drink and for alerting a user when such an attempt has taken place. In more detail, the system includes a device consisting of a lid, housing, cover, or other suitable object that can fit over the mouth of a beverage container. In a preferred embodiment, the exterior of the device is a housing configured to accept the placement of a standard coaster on top of the device and to hold the coaster in place. This arrangement allows the device to fit under a coaster when a beverage is placed on the coaster. Alternately, the upper surface of this housing can be made of a coaster-like material, i.e., an absorptive paper product, eliminating the need for a separate coaster.

Whether the device is coupled with a coaster or not, it is equipped with, contains or consists of a sensor for detecting movement of the device. In a preferred embodiment, the sensor is an accelerometer capable of detecting acceleration in at least one axis such that when the device is moved, the sensor detects the movement. In yet another preferred embodiment of the device, the accelerometer is capable of detecting acceleration in more than one axis and in yet another preferred embodiment, the sensor is a 3 axis accelerometer. The device also is equipped with, contains or consists of a software enable processor or CPU that receives information from the sensor. In a preferred embodiment, the processor is capable of activating an alarm of some kind, for example, one or more lights, speakers, motors or other means of alerting the user, when data is received from the sensor, i.e., when the sensor is moved, the processor receives data and activates the alarm. In yet another embodiment of the device, the processor is coupled with a transmitter such that when the processor receives information regarding movement of the sensor; it can transmit that data to an external device such as a cell phone equipped with a second processor enabling the external device to communicate with the user. In this embodiment, the transmitter consists of an antenna, possibly a Bluetooth antenna.

The software that enables the external processor to receive information from the processor in the device can be programmed to perform a myriad of tasks. It is envisioned that in the best mode of this system, the external processor is enabled by software that comprises a cell phone application or “app” that can be programmed to perform any number of social networking services such as communicating with other devices and users, operating the alarm(s), and communicating with social media sites such as Facebook or other applications.

The software that enables the processor in the device can be programmed to ignore or fail to act when it receives certain types of data from the sensor. That way, the system can be programmed to ignore certain movements, for example, any movement or acceleration caused by bumping or hitting the surface upon which the beverage and sensor rest. The software can also be programmed to ignore or fail to act when the sensor is moved laterally allowing someone to move the beverage along the surface on which it rests without activating the alarm.

The Applicant further envisions a coaster device containing a processor and/or transmitter that enables it to send or receive data from the device, such as an identifier code that in turn can initiate an interaction with the device. An additional embodiment of the system entails using a magnet, magnetic or ferrous material or a permanent magnet that interacts with an electromagnet located in the housing. Using the electromagnet, the user can attract or repel the coaster to or away from the housing 10 allowing the user to either secure the coaster to the housing or to “eject” the coaster from the housing.

### BRIEF DESCRIPTION OF THE SEVERAL VIEWS OF THE DRAWING(S)

FIG. 1 is a top plan view of the warning system disclosed in this application; and

FIG. 2 is a perspective view of the warning system engaged with the mouth of a beverage container.

### DETAILED DESCRIPTION OF THE INVENTION

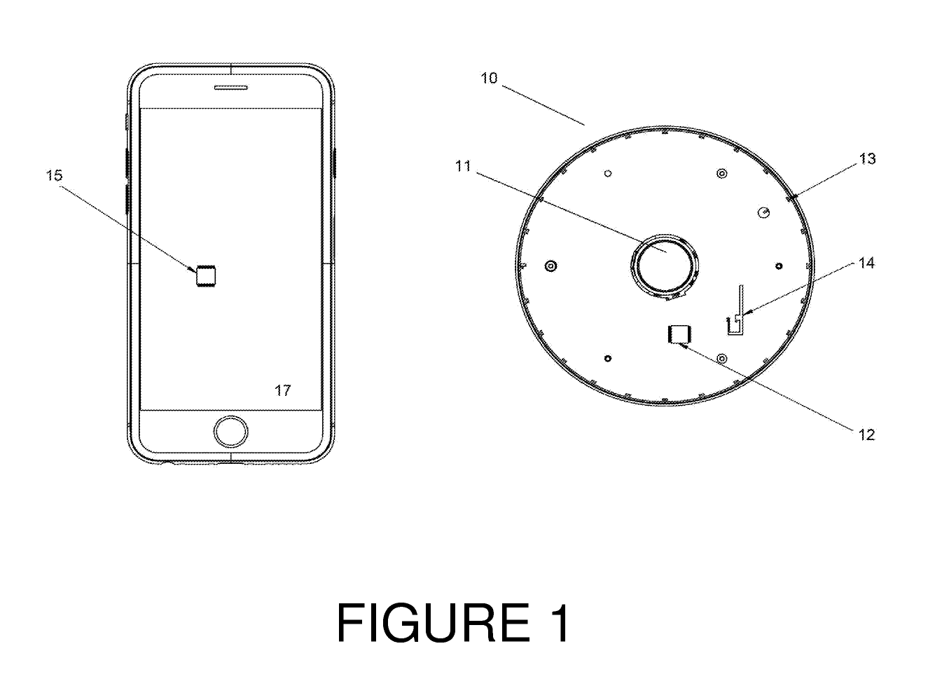

Referring now to the invention in more detail, FIG. 1 shows the deterrent and alert system disclosed by this application. The system includes a housing 10 that consists of or functions as a lid. The housing 10 contains a sensor 11 that detects movement and an internal processor (CPU) 12 that receives information from the sensor 11 and activates an alarm 13 in response to receiving information from the sensor 11 indicating the sensor 11 has detected movement or has been moved. Another embodiment includes a transmitter 14 through which the processor 12 transmits data to an external processor (CPU) 15. In this embodiment of the system, the external processor 15 can be integrated into any number of devices such as a cell phone, iPhone, tablet, notebook or laptop computer, desktop computer, etc. In the preferred embodiment, the external processor 15 can be used to communicate with the processor 12 in the device. The inventors also envision an embodiment in which the external processor 15 communicates with an electronic display 17 such that the external processor causes information to be displayed to the user through the display 17 when the sensor 11 detects movement. Thus a user would be able to use an external device such as a cell phone with an app to activate or deactivate the sensor 11 or the alarm 12 and/or to transmit information from the device to another cell phone or any number of other devices.

In more detail, still referring to the invention of FIG. 1, system as shown includes a housing 10, generally shaped to easily fit over the mouth of a beverage container (not shown), i.e., the housing 10 functions as a lid. In some embodiments, the housing 10 will be sized to fit snugly over a beverage container, but in the preferred embodiment and best mode, the housing 10 is a “one size fits all” housing that is large enough to be placed over the mouth of most beverage containers. The housing 10 contains a sensor 11 that detects movement or agitation such that when the sensor 11 is displaced it transmits data to a processor 12 with which it is in electronic communication. The processor 12 thereby detects when the housing 10, including the sensor 11, is moved. The internal processor 12 can then activate an alarm 13 and/or it can transmit a signal to a transmitter 14 to be transmitted to an external processor (CPU) 15. In a preferred embodiment, the device both activates an alarm 13 integrated into the housing 11 and transmits a signal to the external processor 15, which in turn displays information on a display 17 and/or activates an external alarm that is not integrated into the housing 10.

The external alarm (not shown) could be structurally equivalent to the alarm 13 integrated into the housing 10 and can consist of lights, speakers, motors or any other conventional means of alerting the user.

In further detail, still referring to the invention of FIG. 1, the sensor 11 can be any sensor capable of detecting movement including, but not limited to an accelerometer, a gyroscope or a GPS tracking device. In a preferred embodiment of the device, the sensor is an accelerometer that detects acceleration in at least one axis, direction or plane. In the preferred embodiment and best mode of this device, the sensor is an accelerometer that detects acceleration in three axes, i.e., the sensor is a three-axis accelerometer. Similarly, the alarm can take a variety of forms including one or more lights, means of producing auditory alarms, such as speakers and/or means of generating vibration, such as a motor with an attached weight. In addition, the transmitter 14 can include one or more antennae. In the preferred embodiment of the device 10, the transmitter 14 is a Bluetooth antenna.

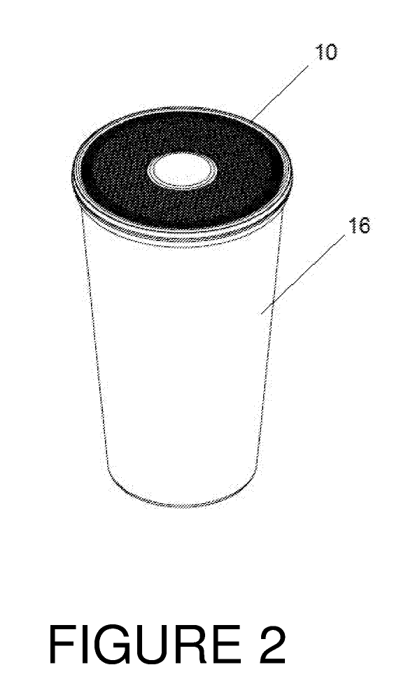

Referring now to the invention in more detail, in FIG. 2 there is shown the device engaged over the mouth of a beverage. In practice, the user places the housing 10 over the mouth of a beverage container 16. The user then activates the sensor (not shown) when they wish to leave their beverage unattended or otherwise direct their attention away from the beverage container 16. If the housing 10 is moved, the internal processor (not shown) receives information about the movement and activates the alarm(s) (not shown). When the alarm(s) are lights or LEDs, the user can visually tell the alarm(s) has been activated and will know that the housing 10 has been moved. In practice, the processor can be programmed such that it does not activate the alarm(s) in response to certain types of movement. For example, the alarm(s) would not be activated in response to the surface upon which the beverage container 16 rests has been struck or jarred. Alternately, the sensor's sensitivity can be adjusted such that no signal is sent to the processor in response to small amounts of movement, such as when the surface on which the device is resting is struck or jarred. In addition, the internal processor 12 or sensor(s) 11 can be configured such that the alarm(s) 13 will not be activated by lateral movement, such as when someone slides the beverage container 16 along a flat surface. In the preferred embodiment, the internal processor 12 is configured to activate the alarm 13 when it detects vertical movement, such as when someone moves the housing 10 away from the mouth of the beverage container 16 to introduce a foreign substance into the beverage. In the preferred embodiment, the sensor 11 will be sensitive enough to detect the vibrations of a person's hand.

Referring back to FIG. 1, in the preferred embodiment of the system, the device includes a means of transmission 14 such as an antenna that transmits data from the processor 12 in the device 10 to a second processor 15 located in an external device. As a result, when the device 10 including the sensor 11 is moved, the processor 12 will transmit data to an external device such as a cell phone enabled with software allowing the user to receive a signal, alarm or other message. Furthermore, the external processor 15 can be programmed to enable the user to communicate with and control the device—activating the alarm 13 for example. Still further, the external device can be social media enabled allowing the user to communicate with other users with similar devices, or to post and receive information electronically.

Thus the disclosed system allows a means for a user to be alerted to attempts to contaminate or otherwise introduce a substance into the user's beverage. Furthermore, the device can be used to display information or advertising and thus can be used as a promotional tool. In addition, the system enables users to interact with each other as well as their devices and can be used as part of a social media platform.

Reference throughout the specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout the specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

It is understood that the above described embodiments are only illustrative of the application of the principles of the present invention. The present invention may be embodied in other specific forms without departing from its spirit or essential characteristics. The described embodiment, including the best mode, is to be considered in all respects only as illustrative and not restrictive. The scope of the invention is, therefore, indicated by the appended claims, if any, in conjunction with the foregoing description.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

I claim:

1. A deterrent and alert system for use with a beverage container comprising:
a housing equipped with at least one sensor, an internal processor and at least one alarm;
wherein the sensor is capable of detecting movement in at least one axis;
wherein the internal processor capable of receiving and interpreting information from the sensor; and
wherein the internal processor activates the at least one alarm in response to receiving data from the sensor.

2. The deterrent and alert system as claimed in claim 1 wherein the sensor is an accelerometer capable of detecting acceleration in at least one axis.

3. The deterrent and alert system as claimed in claim 1 wherein the sensor is an accelerometer capable of detecting acceleration in at least three axes.

4. The deterrent and alert system as claimed in claim 1 wherein the sensor is a gyroscope.

5. The deterrent and alert system as claimed in claim 1 further comprising a transmitter that transmits data from the internal processor to an external processor located in an external device; wherein the external processor is capable of activating an external alarm in response to receiving information from the internal processor.

6. The deterrent and alert system as claimed in claim 2 further comprising a transmitter that transmits data from the internal processor to an external processor located in an external device; wherein the external processor is capable of activating an external alarm in response to receiving information from the internal processor.

7. The deterrent and alert system as claimed in claim 3 further comprising a transmitter that transmits data from the internal processor to an external processor located in an external device; wherein the external processor is capable of activating an external alarm in response to receiving information from the internal processor.

8. The deterrent and alert system as claimed in claim 4 further comprising a transmitter that transmits data from the internal processor to an external processor located in an external device; wherein the external processor is capable of activating an external alarm in response to receiving information from the internal processor.

9. The deterrent and alert system as claimed in claim 5 wherein the external processor transmits information to an external display in response to receiving information from the internal processor.

10. The deterrent and alert system as claimed in claim 6 wherein the external processor transmits information to an external display in response to receiving information from the internal processor.

11. The deterrent and alert system as claimed in claim 7 wherein the external processor transmits information to an external display in response to receiving information from the internal processor.

12. The deterrent and alert system as claimed in claim 8 wherein the external processor transmits information to an external display in response to receiving information from the internal processor.

13. A deterrent and alert system for use with a beverage container comprising:
a housing equipped with at least one sensor, an internal processor, and a transmitter; wherein the sensor is capable of detecting movement in at least one axis, the internal processor is capable of receiving and interpreting information from the at least one sensor, and the transmitter is capable of receiving data from the internal processor and transmitting data to an external processor located outside of the housing.

14. The deterrent and alert system of claim 13 wherein the external processor is capable of activating an alarm in response to receiving information from the transmitter.

15. The deterrent and alert system of claim 13 wherein the external processor is capable of displaying information on a display in response to receiving information from the transmitter.

16. The deterrent and alert system as claimed in claim 13 wherein the sensor is an accelerometer capable of detecting acceleration in at least one axis.

17. The deterrent and alert system as claimed in claim 13 wherein the sensor is an accelerometer capable of detecting acceleration in at least three axes.

18. The deterrent and alert system as claimed in claim 13 wherein the sensor is a gyroscope.

19. A method of using a deterrent and alert system with a beverage container comprising:
providing a housing with a sensor capable of detecting movement;
providing the housing with a processor capable of receiving and interpreting data from the sensor;
providing the processor with a transmitter capable of communicating with a second processor external to the housing and enabled with software configured to alert a user when a signal is received;
placing the housing over the opening of a beverage container and
activating the sensor such that when the sensor detects movement of the housing a signal is sent to the second processor causing it to alert the user of the detected movement.

20. The method of claim 19 wherein the sensor is an accelerometer capable of detecting acceleration in at least three axes.
